(19) United States
(12) Patent Application Publication
(10) Pub. No.: US 2007/0001927 A1
(43) Pub. Date: Jan. 4, 2007

(54) Tiled display for electronic signage

(75) Inventors: Theodore K. Ricks, Rochester, NY (US); James S. Honan, Spencerport, NY (US); Carolyn R. Ellinger, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/174,326

(22) Filed: Jul. 1, 2005

(51) Int. Cl. G09G 5/00

(52) U.S. Cl. 345/1.1

(57) ABSTRACT

An electronically updatable, tiled display having overlapping display elements is disclosed, wherein an entire viewing area of the tiled display is addressable, and the tiled display can be expanded, collapsed, folded, or rolled.

### FIELD OF THE INVENTION

The present invention relates to a tiled, electronic display, signage systems including such displays, and methods of forming the same.

### BACKGROUND OF THE INVENTION

Large format electronic signs are becoming popular in retail stores, restaurants, and billboards as a means by which to attract consumer attention. For example, advertising can be specifically targeted to specific groups or times of day without accruing the cost and labor associated with reprinting new information. The customer benefits by having up-to-date information about products and services, and the retailer benefits by having programmable information that can be readily changed by various electronic means.

Electronic signs have been made using traditional display technologies, such as cathode ray tubes (CRTs), liquid crystal displays (LCDs), plasma displays, projectors, and light emitting diode (LED) assemblies. These technologies provide dynamic, full-color imagery, but in return require complex, expensive electronics and constant power, significantly increasing the weight, size, and cost of the signage including such displays. These issues can become especially significant in large format signs. Assembled LED display elements can be made very large, but that size comes at a significant expense, as each LED is individually placed. Other display technologies such as CRT, LCD, plasma, or rear projection display elements are made in bulk processes, but are limited in maximum size due to manufacturing line, yield, or space considerations. Therefore, the only reasonable method to expand these display technologies to form very large signs is by tiling multiple display elements. Tiled displays are made by producing small display elements on existing manufacturing lines at a high yield, then assembling them into a horizontal and/or vertical array to form a single, large display. These small display elements typically have some amount of unaddressable area around the viewing area perimeter, so resulting tiled displays often have obvious gaps between tiled display elements. The final assembly is also typically extremely heavy, expensive, power-hungry, and highly sensitive to handling.

The advent of bistable, reflective display technology has enabled a new breed of electronic sign, which is capable of maintaining images indefinitely without the constant application of power, greatly increasing power efficiency in sign applications. Also, many bistable display technologies are well suited to reduced electronics in the form of a passive matrix drive system. Such a drive system reduces electronics cost, and allows the further benefit of enabling input connections to the display element to be routed to one or more edge of the display element. This enables greater freedom with drive electronics placement.

In U.S. Pat. No. 5,673,091, Boisdron and Chaudagne take advantage of passive matrix, bi-stable display elements to produce a power-efficient, tiled sign with reduced horizontal gaps in viewing area produced by overlapping display elements vertically to hide the electronic interconnect area. In WO2004/051609, Ben-Shalom et al. constructs a similar structure to hide a glass seal area. This is somewhat effective when viewed from a single direction, but results in more significant gaps in the viewing area when viewed from certain other directions, and produces a significantly non-flat display. Neither method addresses the gaps between horizontally tiled arrays, as both references describe abutting of display elements in the horizontal direction. These systems still utilize glass display elements, yielding large, heavy assemblies that are sensitive to handling.

In US 2004/0256977, Aston modifies the overlapping system by generating two-dimensional arrays with OLED display elements, which can be overlapped in multiple directions. Although this system improves the appearance of the display viewing area from one direction, the appearance from other directions still would be compromised. Further, the display still suffers from the same limitations of the above-described references, that is, having issues with handling and flatness of the display.

In U.S. Pat. No. 6,252,564, Albert and Comiskey utilize flexible display elements to reduce weight while improving flatness and handling of the system. However, they do not overlap the display elements, eschewing the ability to hide seams or unaddressable areas in an effort to reduce gaps between display elements.

There is a need for a large format display system that is substantially flat, power efficient, and viewable from all directions without noticeable gaps between display elements. Furthermore, it is desirable for such a system to be lightweight, robust to handling, easily transportable, and adaptable in size and shape.

### SUMMARY OF THE INVENTION

An electronic, rewritable display, and a signage system incorporating the display, are described, as well as methods of forming the same, wherein the display has a viewing area comprising a plurality of display elements, each of the plurality of display elements comprising an overlap area, an access area, an interconnect area, and a display area, wherein the overlap area of at least one of the plurality of display elements overlaps at least a portion of the display area of at least a second one of the plurality of display elements, and wherein at least a portion of one of the plurality of display elements is flexible.

### ADVANTAGES

The electronically updatable, tiled display can be used to display large images, wherein the display is substantially flat and can be viewed from multiple viewing directions with minimal visible demarcation between display elements. The system can use minimal power, be lightweight, be portable, have a reduced cost, or a combination thereof. The system can be expandable and contractable to provide for easy transport and to provide an easily adaptable viewing area size and shape.

### BRIEF DESCRIPTION OF THE DRAWINGS

The invention as described herein can be understood with reference to the accompanying drawings as described below:

FIG. 1 is a front view of a thin film display element with interconnects along multiple sides;

FIG. 2 is an isometric view from the back of the thin film display element of FIG. 1;

FIGS. 3A and 3B are a front and a cross-sectional view, respectively, of a large-format, tiled display with multiple-side interconnects and display elements overlapping in vertical and horizontal directions;

FIG. 4 is an isometric back view of a large-format, tiled display with multiple-side interconnects and display elements overlapping in vertical and horizontal directions;

FIG. 5 is an exploded isometric view of a large-format, tiled display with a laminate sheet over the front of the display;

FIG. 6 is a front view of a large-format, two-element, tiled display with multiple side interconnects;

FIG. 7 is a front isometric view of a large-format, tiled display formed of overlapping long, individual display elements;

FIG. 8 is a front view of a large-format, tiled display formed of overlapping looped display elements;

FIG. 9 is a cross-section of the display in FIG. 8 along line A-A;

FIG. 10 is a back view of a thin film display element with single-side interconnects;

FIGS. 11A and 11B are a front and a side view, respectively, of a large-format, tiled display assembly;

FIG. 12 is a front view of a thin film display element to be used in a non-rectangular tiled application with single-side interconnects;

FIG. 13 is a front view of a non-rectangular tiled display;

FIG. 14 is a back view of a large-format, tiled display with continuous rows and columns;

FIGS. 15A and 15B are a front and a side view, respectively, of a rail system for use in supporting and powering a tiled display; and

FIG. 16 is a side view of a large-format, tiled display telescoping to and from a collapsed state.

The drawings are exemplary only, and depict various embodiments of the invention. Other embodiments will be apparent to those skilled in the art upon review of the accompanying text.

### DETAILED DESCRIPTION OF THE INVENTION

An electronic, rewritable display can be used in a signage system. The display can include one or more display elements capable of displaying an electronically updateable image, wherein the display elements can be overlapped to form a linear or multidimensional array. The pixels of each display element can be aligned with those of adjacent display elements to give the appearance of a single, larger display, hereafter referred to as a “tiled display.” The tiled display can be assembled such that each display element can be connected to one or more electronic driver. Alternatively, the tiled display can be assembled such that some or all of the display elements can share an electronic driver. The tiled display can be constructed such that it can be rolled, folded, collapsed, or disassembled to reduce the viewing area size or for purposes of transportation or storage. The tiled display can be assembled, telescoped, unfolded, or unrolled to view the display or to increase the viewing area of the display.

Each display element in a tiled display can have an access area, an interconnect area, a display area, and an overlap area. The access area corresponds to the portion of the display element that enables electrical access to otherwise inaccessible electrodes within the display element. The access area is not itself capable of electronically displaying information. The access area can be of any size, shape, or placement on the display element. The interconnect area corresponds to the portion of the display where electrical connections are made to external display electronics, for example, a driver. The interconnect area can include all or a portion of the access area, the display area, or a combination thereof. The interconnect area can be along one or more edge of a display element, or can be placed in one or more areas of a display element not along an edge. The display area of the display element is the area of the display element capable of electronically displaying information, and does not include any access areas. The overlap area of a display element is that portion of a display element that overlaps an adjacent display element. The overlap area can include all or a portion of the interconnect area, all or a portion of the display area, all or a portion of the access area, or a combination thereof. Preferably, the overlap area includes all or a portion of the display area. The area of an adjoining display element that is overlapped can include all or a portion of the interconnect area, all or a portion of the display area, all or a portion of the access area, or a combination thereof. It is desirable that the access area of each display element is hidden from view by either the overlap portion of an adjacent display element or a case holding the tiled display, or is along the external edge of a viewing area of the tiled display. A viewing area is an electronically updatable area of the tiled display having no obvious gaps in the display image, and which is viewable by an observer.

At least a portion of each display element can be flexible, such that the overlap portion of a first display element can lie flat against an overlapped element. To be flexible, an individual display element can include a flexible substrate. The substrate can be a polymeric material, thin glass, or quartz. The flexible substrate must have sufficient thickness and mechanical integrity so as to be self supporting, yet should not be so thick as to be rigid. Examples of suitable polymeric substrate materials can include, but are not limited to, polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl α-methacrylates)), an aliphatic or cyclic polyolefin, polyarylate (PAR), polyetherimide (PEI), polyimide (PI), Teflon poly(perfluoro-alkoxy)fluoropolymer (PFA), poly(ether ether ketone) (PEEK), poly(ether ketone) (PEK), poly(ethylene tetrafluoroethylene)fluoropolymer (PETFE), poly(methyl methacrylate), and various acrylate/methacrylate copolymers (PMMA). Aliphatic polyolefins can include high density polyethylene (HDPE), low density polyethylene (LDPE), and polypropylene, including oriented polypropylene (OPP). Cyclic polyolefins can include poly(bis(cyclopentadiene)). A preferred flexible plastic substrate can be a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo, Japan; and Topas® made by Celanese A. G., Kronberg, Germany. Arton is a poly(bis(cyclopentadiene)) condensate that is a polymeric film. Alternatively, the flexible substrate can be a polyester, for example, an aromatic polyester such as Arylite.

The display element can be formed with a rewritable, electronic display material and one or more conductive layer formed in a pattern on the substrate, such that the display can be written as a passive matrix in rows and columns. Alternatively, the display element can be written as an active matrix by individual activation of each pixel or segment of the display element. The display element can be designed such that electrical traces can be routed to one or more different edge of the display element, one or more areas of a display element not along an edge, or some combination thereof. The interconnect area includes the portions of the electrical traces to which external display electronics are connected. For example, in the case where traces are arrayed into rows and columns, the interconnect area for the rows and columns can be on different edges of the display element, on one edge of the display element, or interspersed on two or more edges of the display element. The display element can be designed such that the display area defined by the rows and columns or patterning of the conductive layers is larger in any direction than the interconnect area required to drive the display element.

The display element can include electrically modulated materials, for example, electrochemical materials; electrophoretic materials, including those manufactured by Gyricon, LLC of Ann Arbor, Mich. (see U.S. Pat. No. 6,147,791, U.S. Pat. No. 4,126,854, and U.S. Pat. No. 6,055,091), and E-ink Corporation of Cambridge, Mass.; electrochromic materials; electrowetting materials; light emitting diodes; magnetic materials; and liquid crystal materials. The liquid crystal materials can be twisted nematic (TN), super-twisted nematic (STN), ferroelectric, magnetic, or chiral nematic liquid crystal materials. Chiral nematic liquid crystals can be polymer dispersed liquid crystals (PDLC). Suitable chiral nematic liquid crystal materials include a cholesteric liquid crystal disclosed in U.S. Pat. No. 5,695,682, and Merck BL112, BL118 or BL126, available from EM Industries of Hawthorne, N.Y. Organic or polymer light emitting diodes (OLEDs) or (PLEDs) are described in the following patents: U.S. Pat. Nos. 5,707,745; 5,721,160; 5,998,803; 5,757,026; and 6,125,226 to Forrest et al.; U.S. Pat. Nos. 5,834,893 and 6,046,543 to Bulovic et al.; U.S. Pat. Nos. 5,861,219; 5,986,401; and 6,242,115 to Thompson et al.; U.S. Pat. Nos. 5,904,916; 6,048,573; and 6,066,357 to Tang et al.; U.S. Pat. Nos. 6,013,538; 6,048,630; and 6,274,980 to Burrows et al.; and U.S. Pat. No. 6,137,223 to Hung et al.

According to various embodiments, the display element can maintain a desired image, such as text, graphics, symbols, or characters, without power by using a bistable material. This reduces power requirements of the display element, and can improve the life of the display element where the display element has a self-contained power source, such as a battery. Bistable displays can be formed by methods known in that art of display making. Suitable bistable materials can include electrochemical materials; electrophoretic materials; electrochromic materials; magnetic materials; and chiral nematic liquid crystal materials. The bistable materials can maintain a given state indefinitely after the electric field is removed. According to various embodiments, one or more conductive layer can be provided external to the bistable media.

Wherein the bistable material includes a liquid crystal material, a support having a first conductive layer can be coated with the bistable material or a pre-formed layer of the bistable material can be placed over the first conductive layer. A second conductive layer can be formed over the bistable material to provide for application of electric fields of various intensity and duration to the bistable material to change its state from a reflective state to a transmissive state, a transmissive state to a reflective state, or from any state to a desired grey scale level. The access area is the portion of the display where the bistable material and second conductive layer do not interfere with the ability to make electrical connections to the first conductive layer, for example, wherein the bistable material and second conductive layer have not been coated, have been removed, or have been selectively patterned to allow electrical connections to be made to the first conductive layer.

The first conductive layer can be patterned, for example, into parallel lines. The second conductive layer can be patterned non-parallel to the patterning of the first conductive layer such that the intersection of the first conductive layer and the second conductive layer forms a pixel. The second conductive layer can be patterned in the form of individual pixels. The second conductive layer can be electrically conductive segments formed over the bistable material layer by thick film printing, sputter coating, or other printing or coating means. The conductive segments can be any known aqueous conductive material, for example, carbon, graphite, or silver. An exemplary material is Electrodag 423SS screen printable electrical conductive material from Acheson Corporation. The conductive segments can be arranged to form pixels of any shape, numbers 0-9, a slash, a decimal point, a dollar sign, a cent sign, or any other character or symbol. The optical state of the bistable material between the first conductive layer and the second conductive layer can be changed by selectively applying an electrical drive signal across the bistable material. This signal can be a voltage, current, or any combination thereof. The signal can be applied to the second conductive layer and to the first conductive layer by direct or indirect contact, if they are present in the media. For any conductive layer not present in the media, the signal can be applied to selected areas of the bistable material through direct or indirect contact of one or more external electrode to the bistable material. Once the optical state of the bistable material has been changed, it can remain in that state indefinitely without further power being applied to the conductive layers. Methods of forming various bistable display elements are known to practitioners in the art. For example, bistable liquid crystal displays are taught in U.S. Ser. No. 10/134,185, filed Apr. 29, 2002 by Stephenson et al., and U.S. Ser. No. 10/851,440 filed May 21, 2004, to Burberry et al. Depending on the material selected for the display element, color can be added through the use of filters, colored translucent polymeric films, and direct coloration of the display material by manipulation of the material or addition of colorants to the display material, or a carrier or binder containing the display material. For example, when the display material is a liquid crystal material, different colors can be achieved by adjusting the pitch of the liquid crystals, or by adding a colorant thereto. Suitable materials and techniques for adjusting color of various display materials will be apparent to practitioners in the art.

To enhance visibility of certain display materials, for example, liquid crystal materials, a colored layer, often referred to as a dark layer, of light absorbing material can be positioned on a side of the display material opposing the incident light. In the case of liquid crystal display material, in the fully evolved focal conic state the cholesteric liquid crystal is transparent, passing incident light which is absorbed by the dark layer to provide a colored, typically black, image. The dark layer can be a radiation reflective layer or a radiation absorbing layer of any color, so long as it provides a contrast to the liquid crystal in the planar state, or, for other display materials, the display material in at least one state. The dark layer can include milled, nonconductive nanopigments having a diameter less than 1 micron. The dark layer can include multiple pigment dispersions. Pigments suitable for use in the dark layer can be any colored materials that are not soluble in the medium in which they are incorporated. Suitable pigments include those described in Industrial Organic Pigments; Production, Properties, Applications by W. Herbst and K. Hunger, 1993, Wiley Publishers. These include, but are not limited to, pigments including azo pigments such as monoazo yellow and orange, diazo pigments, naphthol pigments, naphthol reds, azo lakes, benzimidazolone pigments, diazo condensation pigments, metal complexes, isoindolinone and isoindolinic pigments, polycyclic pigments such as phthalocyanine, quinacridone pigments, perylene pigments, perinone pigments, diketopyrrolo-pyrrole pigments, thioindigo pigments, and anthriquinone pigments such as anthrapyrimidine.

For different display materials, more than one color can be formed on a single display element by use of various materials, for example, more than one colorant, more than one dark layer material, more than one conductive layer material, or a combination thereof. For example, the use of carbon and silver conductive materials in one of the conductive layers of a liquid crystal display can result in different color sets using the same coated, chiral nematic liquid crystal dispersion and color contrast layer. One or more display element can be color-changing. U.S. patent application Ser. No. 11/021,766 filed Dec. 21, 2004, to Ricks et al., describes an electronically updateable, color-changing display that can be used to display images in a variety of colors, wherein both the content and color of the image can be updated remotely. This enables individual change of the color of all or a portion of each display element within a tiled display, and can enable multiple areas of the display to be the same or different colors. The tiled display can include any mix of full color, partial color, monochrome, or bi-chrome display elements.

Each display element can be flexible. The display element can be made in any shape, for example round, rectangular, parallelogram, square, curved, or irregular. The display element can also be any size. Exemplary display elements can be rectangular, ranging from square sheets to long strips of display material, including loops of display material. Any desirable shape can be formed by proper cutting of a display element while maintaining an edge-to-edge display area over all but an interconnect portion of the display element. Two or more display materials can be combined into a single, larger display material for use in a large display element by any joining means, for example, taping, splicing, gluing, stitching, clamping or stapling. The display material and resulting element can be in the form of a loop.

The tiled display can have two or more display elements, for example, two, three, or more display elements. Each of the display elements within the tiled display can be of any desired size or shape. The tiled display can be made of uniformly sized display elements, uniformly shaped display elements, a combination of element sizes, or a combination of element shapes, including combining looped and sheet-type display elements. The tiled display can have any three dimensional shape, for example, flat, curved, round, spheroid, polygonal, square, cubed, or irregular. The tiled display can be double-sided, having at least one viewing area on each side. Where the tiled display is a three dimensional shape, such as a polygon, each face of the shape can include at least one viewing area. When the tiled display is curved, such as a sphere, one or more viewing areas can be present. Each viewing area of the tiled display, regardless of the tiled display shape, can include two or more display elements. The display elements can be arranged in a pattern, for example, a grid, a geometric shape, a symbol, a character, or a random pattern. Each display element can overlap or be overlapped by at least one other display element within the tiled display. The display elements and tiled display including the display elements can be formed by methods known in that art of display making. Each display element can be matrixed, segmented, or a combination thereof.

An electrical drive signal can be provided to each display element by display drive electronics, for example, a circuit board, connected to the interconnect area, in order to change an image on all or a portion of each display element. The display drive source can be permanently or removably attached to the interconnect area of the display element. The display drive source can include an internal power source, such as a battery, or can be connected to an external power source, for example, a battery, an electrical circuit, a solar cell, or other power source. The display drive source can be connected to the display element physically. The display drive source can be electrically connected to the display element directly or through some secondary connections, such as wires. The data for forming an image can be provided by a computer or other data source through wired or wireless communication with the display drive source. The display element can be driven by one or more display drive source. A tiled display can have one or more display drive source, such that the entire display is driven by one drive source, two or more display elements are driven by a common drive source, or each display element has one or more distinct drive source.

The drive electronics can be positioned within the access area, within the display area, or some combination thereof. The drive electronics can extend beyond one or more edges of the display element, The drive electronics can be designed to interact with the display element to apply the appropriate drive signal to change only selected areas of the display element. The display element and drive electronics can move relative to one another as described in U.S. patent application Ser. No. 11/021,765, filed Dec. 21, 2004, to Ricks et al. The drive electronics can be sized to cover one dimension of the display element, for example, the width of the display element, or two or more sets of drive electronics can be used together to cover the desired portion of the display element. The drive electronics can be made large enough to address the entire display element at once, in which case relative motion of the drive electronics and display element is unnecessary, and the drive electronics can write all or a portion of the display element at a time, for example, by use of an active or passive drive matrix. The drive electronics can be sized to cover all or a portion of more than one display element so as to write more than one display element at a time, and can be as large as the entire viewing area. When drive electronics are used to address one or more display elements, the display element(s) and drive electronics can be moved relative to each other to allow the drive electronics to address various sections of the display element(s). The display element can form a loop, such that the drive electronics can continuously address the entire display element.

The display including two or more display elements can further include a case or frame, hereinafter referred to as a “case.” The case can conceal one or more portions of one or more display element from view, forming one or more viewing areas of any size or shape. The case can additionally enclose portions of one or more of the display elements and any associated electronics, for example, a display drive source. The electronics can also be a separate device, and can write one or more display element before the display element is placed to form a tiled display, or after. The case can be any material, for example, plastic, paper, metal, ceramic, liquid, gelatin, view-obstructing gas, or any combination thereof. The case can have any shape, including, but not limited to, square, rectangular, octagonal, round, cylindrical, spherical, or amorphous. The case can be two- or three-dimensional. The case can be rigid, semi-rigid, flexible, liquid, or gaseous. The case can be opaque, translucent, transparent, or have sections with varying degrees of opacity from opaque to transparent, wherein a transparent area can coincide with a viewing area. The viewing area can be a transparent portion of the case, or an opening through the case. The case can contact one or more edge portions of the tiled display. The case can enclose all or a portion of the tiled display.

A plurality of display elements can be joined to form a tiled display, used for one application, and dissembled at the end of the application life. This same plurality of display elements can then be joined into a different arrangement for use in a second application. For example if the dimensions of each of the display elements were 1 m by 2 m, and the first application required an 8 m by 12 m sign, one could envision a matrix of 48 elements arranged 8 elements by 6 elements. If a second application then required a 6 m by 16 m sign, these same elements could be rearranged into a 6 element by 8 element configuration. Alternatively, these 48 elements could be divided among a number of different format tiled displays.

Positioning of two or more display elements can be done using optical, physical, or electrical alignment features. The alignment feature can be interlocking, such that adjacent display elements interlock on alignment of their respective alignment features. Use of interlocking alignment features can result in precise alignment of the pixels of adjoined display elements. Alignment features can be used for alignment between elements, or between an element and an external reference, for example, drive electronics, a support structure, or a case. The alignment features can be used to align display electronics with the display element columns and rows, segments, or pixels.

Adjacent display elements can be joined by physical or electrical connections that do not function explicitly as alignment features, for example, by connective tape, adhesives, or electrical wires. Suitable fastening materials for adjoining display elements can include repositionable adhesives, tongue and groove systems, tab and slot, Velcro™, and the like. The fastening materials can provide improved alignment of individual display elements, improved electrical connectivity between display elements, or a combination thereof. The fastening materials can be temporarily or permanently affixed to the display elements. The fastening materials can form a temporary or permanent bond between adjacent display elements.

A tiled display can be assembled by overlapping at least one edge of a first display element over at least a portion of the display area of an adjacent element. The portion of the first display element that overlaps the second display element is called the overlap area. The portion of the second display element that is overlapped is referred to as the overlapped area. The overlap area can include all or part of the access area, all or part of the display area, or a combination thereof. Preferably the overlap area includes all or a portion of the display area. Where a first element only overlaps a second element, the overlapped area of the second element is the display area. When the first element additionally overlaps a third element, the overlapped area of the third element can be all or part of the display area, all or a part of the access area, all or part of the interconnect area, or some combination thereof. The elements can be overlapped to form a linear array, a two-dimensional matrix, or a multi-dimensional form. When three or more display elements form a tiled display, the access area of each display element can be hidden from view by either the overlap portion of an adjacent display element or a case holding the tiled display, or can be along the external edge of a viewing area of the tiled display.

The tiled display can be assembled by placing display elements in an overlapped fashion until the desired display size and shape are reached. The display elements can be slidably moved past one another to maximize or minimize an overlap area, thereby increasing or decreasing, respectively, the area of the tiled display. Each overlap area can be the same or different in size and shape from at least one other overlap area in the tiled display. Slidable movement of the display elements allows for concentric storage of the display elements. For example, the display elements can slide past one another to form a stack of display elements as thick as the number of elements high, and as long as the number of elements wide. This can be particularly advantageous where the tiled display is in the form of a loop, U-shaped, or otherwise concentrically shaped, such as in a polygonal form, where one row of display elements can slide past another row to increase or decrease display area.

When one or more display element has a flexible substrate, the flexible display elements can be rolled and unrolled. This enables the tiled display to be rolled up for storage or transport, and unrolled for viewing without damage to the display elements. Similarly, the tiled display can be folded when at least a portion of the display elements are flexible to enable storage and transport.

One or more portion of each display element can be parallel to the plane of the viewing area of the tiled display. Additionally, a portion of the display element can be thin relative to the remainder of the element. For example, at least a portion of the overlap area can be thinner than the remainder of the display element. Alternately, a portion of a display assembly, wherein the assembly includes the display element and associated electronics, can be thinner than the rest of the assembly, for example, the overlap area can be a portion of the display element. This enables a generally uniform, flat viewing area without significant steps between displays, enabling viewing from multiple directions without increased distortion in the displayed image.

When forming the tiled display, supports can be used to aid in alignment, support, and attachment of the display elements, as well as for carrying electrical power or signals. Suitable supports can include rods, bars, racks, tracks, filaments, electrical wires, or other substantially linear materials. The supports can be of any material which can support the weight of one or more display element, can maintain a given shape over time, can provide power to one or more display element, can provide electrical connection to one or more display element, or a combination thereof. For example, the support can be cardboard, wood, plastic, glass, metal, or a fibrous material such as glass, polymers, or natural materials such as cotton, wool or hemp. The support can support the overall shape of the tiled display, for example, a sphere, semicircle, polygon, or rhomboid shape, to which the display elements can be attached or on which the display elements can be overlaid. The support can be used for alignment of one or more display elements. The support can also form all or a portion of a case. The supports can be flexible or rigid as desired for a given tiled display shape. The supports can be collapsible, foldable, or rollable.

One or more tiled display can be used to form a signage system. The signage system can include one or more tiled display to form one or more viewing area. The signage system can include a base capable of supporting the tiled display. The base can be part of or separate from a support or a case. The signage system can include one or more support, a case, or a combination thereof. Drive electronics can be included in the signage system. The drive electronics can be associated with one or more display elements, part of the support system, part of the case, or a combination thereof. The drive electronics can be removable or permanent. The signage system can include a driver for the drive electronics, such as a computer or other database, which can communicate directly or remotely, for example, by known methods of wireless communication, with the drive electronics. The signage system can include more than one electronically updatable sign, each sign including one or more tiled display, wherein all signs in the system are commonly controlled by a single driver. Such a signage system can update all signs simultaneously or in sequence, and each sign in the system can include the same or different information as at least one other sign in the system. The signs of the signage system can be assembled, disassembled, folded, unfolded, rolled, unrolled, collapsed, and expanded as described for an individual tiled display.

All or a portion of each display element in a tiled display or signage system can include a protective layer. The protective layer can be applied to at least a portion of the tiled display once formed. At least a portion of one or more groups of one or more display element within a tiled display or signage system can be covered with a single protective layer before or after assembly into a tiled display. The protective layer can protect the display elements from one or more of moisture, abrasion, heat, sunlight, chemicals, radiation, or other environmental factors. The protective layer can function as an insulation layer, overcoat layer, optical film, or barrier layer. The protective layer can be any material suitable for the intended purpose wherein the material is at least partially transparent or translucent, or has transparent or translucent portions through which the viewing area can be seen. The protective layer can define one or more viewing area by a combination of transparent or translucent and opaque portions over the tiled display. The protective layer can be, for example, but is not limited to, a gas, a liquid, a polymeric film or sheet, or glass.

One or more display element in a tiled display or signage system can be electronically pre-written before assembly of the tiled display or signage system. One or more display element in a tiled display or signage system can be pre-printed before assembly of the tiled display or signage system, wherein a symbol, character, design, or message can be formed on the display element with ink or colorant by any known printing means, including but not limited to ink jet, laser thermal, thermal sublimation, wax transfer, gravure, intaglio, pen, paint, or other printing methods. A symbol, character, design, or message can also be formed by chemical or laser etching, burning, heat, imprinting, embossing, or other means. The printing can be on any portion of a display element, for example, the display substrate or the display material. The printing can be permanent, temporary, or rewritable. The printing can be visible, hidden, or retrievable, for example, as a mark in the display material, as described for example in U.S. patent application Ser. Nos. 11/009,767, 11/009,884, and 11/009,896, all filed Dec. 10, 2004, by Stephenson and Mi.

The tiled display, a system including the same, and a method of forming the display and system can be understood with reference to certain embodiments depicted in the Figures and described below, wherein the embodiments for simplicity all pertain to a display element including a cholesteric liquid crystal display. It will be apparent to practitioners skilled in the art of display making how similar structures can be formed from different display materials. Common reference numerals are used throughout the Figures.

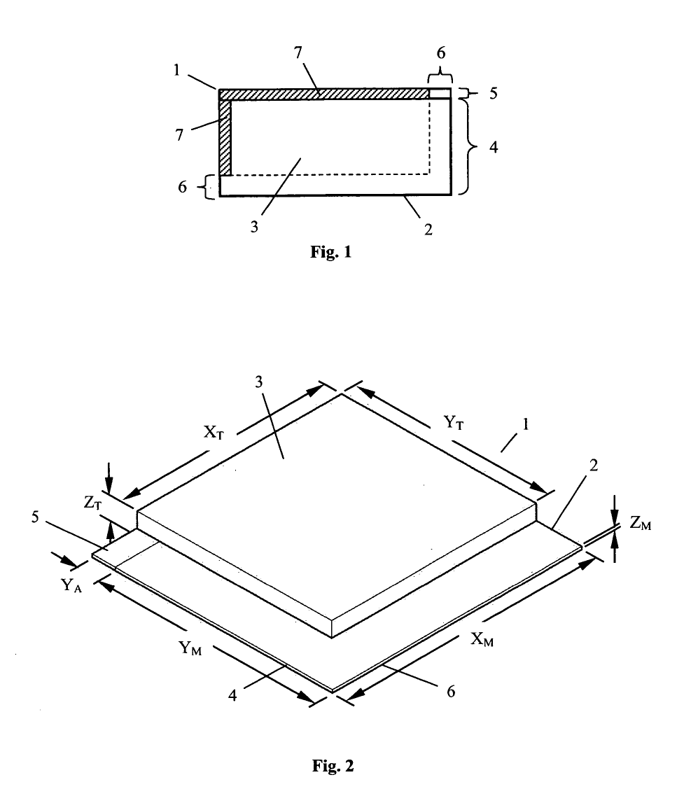

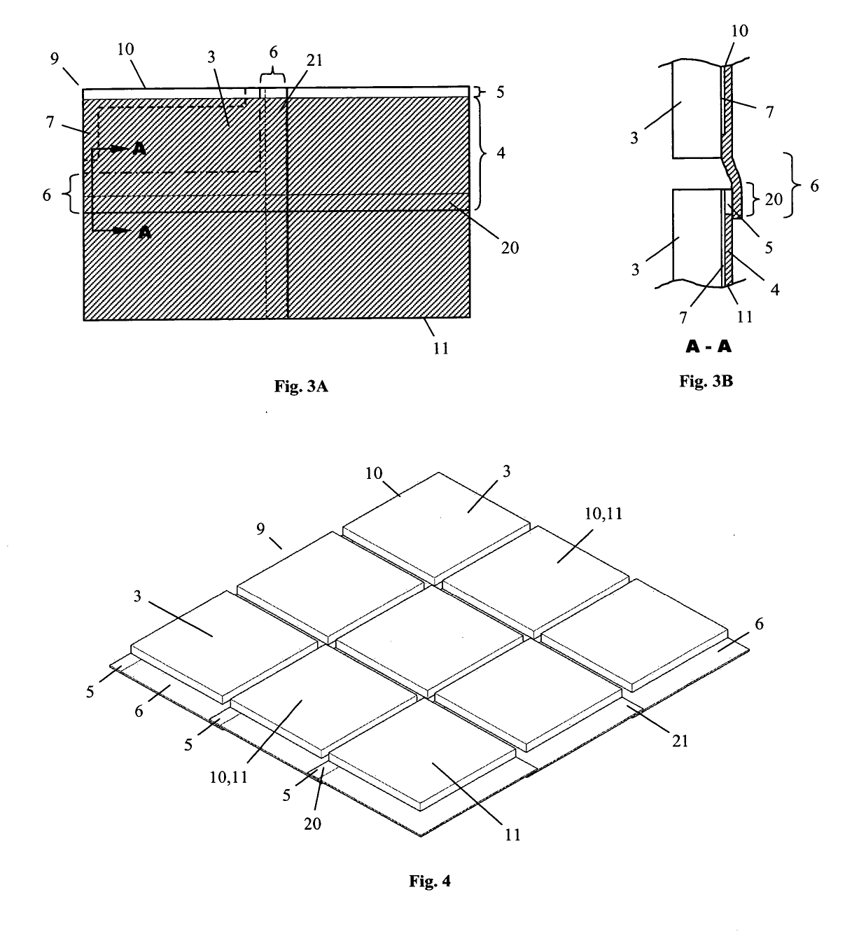

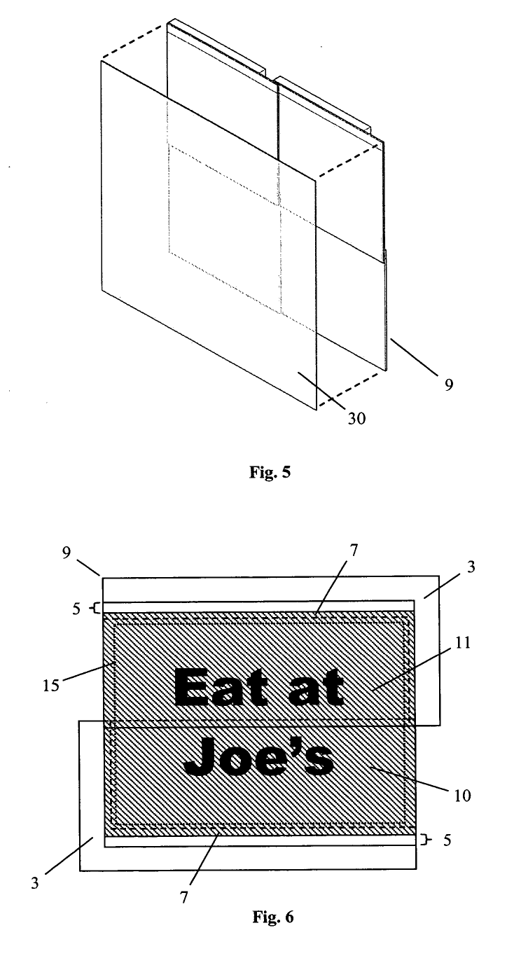

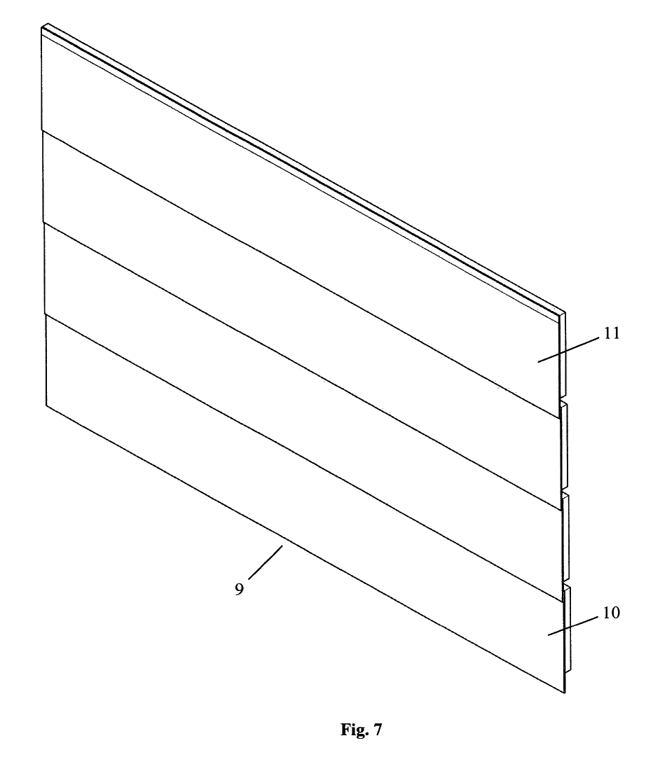

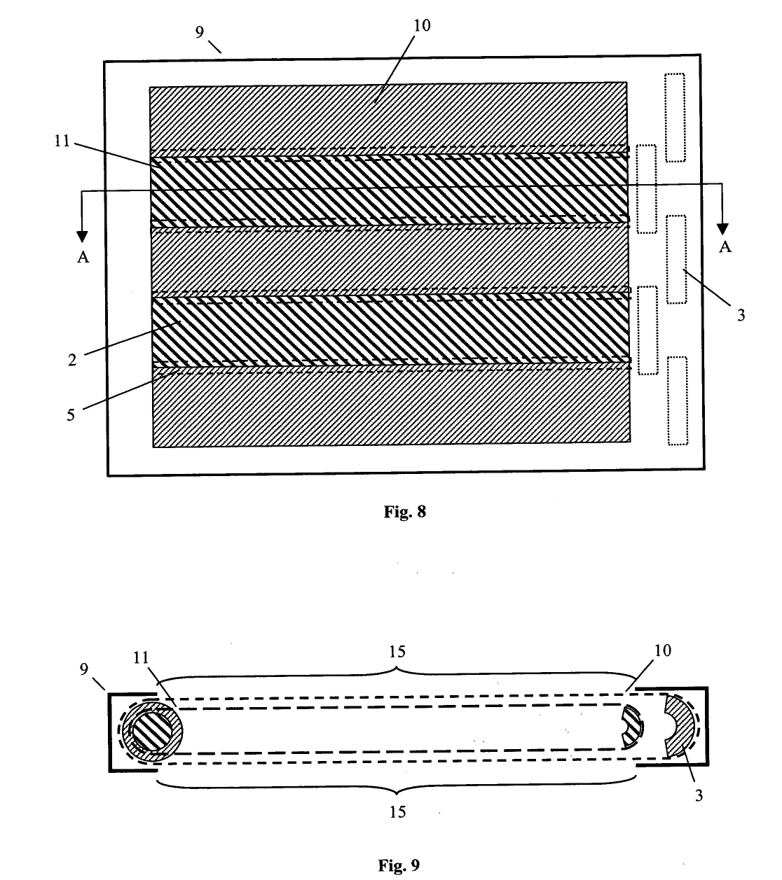

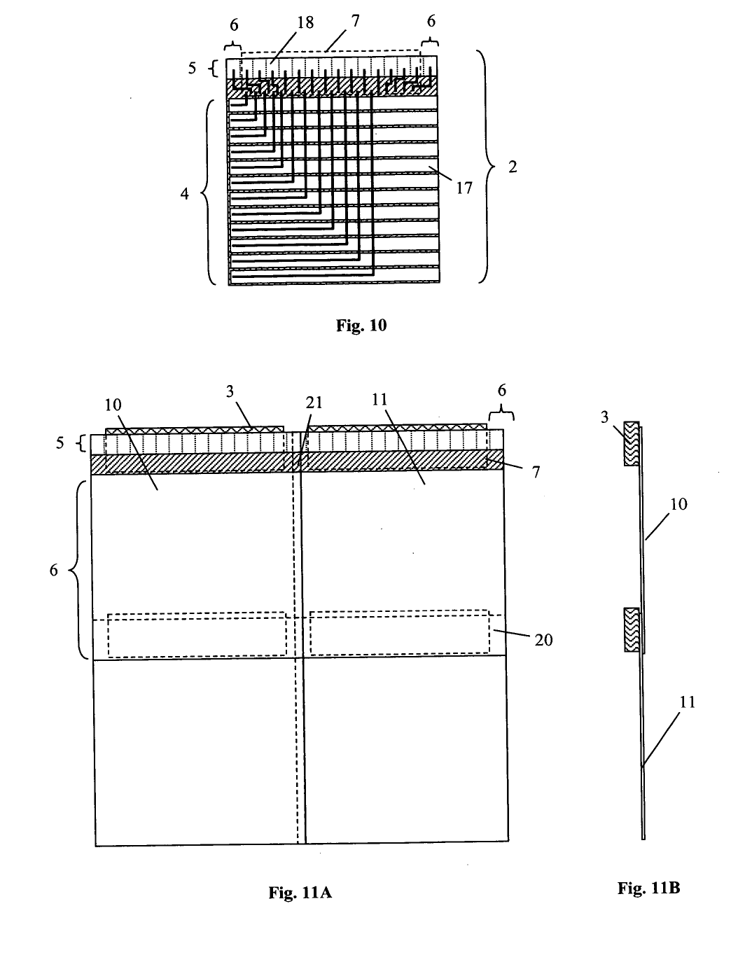

FIG. 1 and FIG. 2 show views of an electronically addressable, single-sided, reflective, display assembly 1 including a display element 2 and display electronics 3. By “single-sided” it is meant that the display element is only viewable from one side. In the exemplified embodiment, the display element 2 has a display area 4, an access area 5, and an interconnect area 7. The display area 4 is a portion of the display element 2 that can be electronically written. The access area 5 is a portion of the display element 2 that cannot be electronically written. The access area 5 can be opaque, translucent, transparent, or a combination therein. The display element 2 can be connected to drive electronics 3 along two edges, as shown in FIGS. 1 and 2. The interconnect area 7 is the portion of the display element 2 to which the drive electronics 3 are electrically connected. The interconnect area 7 can be along one, two, or more edges as desired, or anywhere else on the display. As shown in FIGS. 1 and 2, the display electronics 3 on the display element 2 can cover only a portion of the display area 4.

In FIG. 2, the display assembly 1 has a thickest area dimensioned as X_{T} and Y_{T}, with a total thickness of Z_{T}, which is the sum of the thickness of the display electronics 3, the display element 2, and any additional layers, such as an interconnect promoting adhesive or protective layer. The display area 6 is dimensioned as X_{M} and Y_{M}, with a thickness of Z_{M}, which can be as thin as the display element 2 alone, or can be equal in thickness to Z_{T}. The display element 2 can be as little as 0.10 mm to 2.0 mm thick, although it can be thicker or thinner as desired. The dimension Y_{A} in FIG. 2 is the unaddressable area corresponding to the access area 5. According to various embodiments, X_{T}<X_{M} and Y_{T}<(Y_{M}+Y_{A}), which leaves an unsupported display area 6 in two directions along at least two edges of the display element 2. The thickness Z_{T} of the thickest area can be dominated by the thickness of the display electronics 3. Typical electronic assemblies can range from 0.5 mm to 50 mm thick, although thicker and thinner display electronics can be used.

FIGS. 3A, 3B, and FIG. 4 are front, cross-sectional, and back isometric views, respectively, of a tiled display 9, wherein each tiled display includes multiple overlapping display elements 10 and overlapped display elements 11 forming a matrix of display elements. Overlapping display elements 10 and overlapped display elements 11 can be combined to form a linear array of display elements (see FIG. 7). The display elements 10, 11 can be assembled to form vertical overlaps 20 and horizontal overlaps 21, such that the unsupported area 6 of each overlapping display element 10 covers at least a portion of the access area 5 of one adjacent overlapped element 11. The unsupported area 6 of each overlapping display element 10 can also cover at least a portion of a display area of the same or a different adjacent overlapped element 11. Display elements can be overlapped such that that the same display element has both overlapped and overlapping areas, as seen in FIG. 4.

Due to the relatively thin profile of the unsupported area 6, the tiled display remains substantially flat, even in the overlap areas 20, 21, as shown in FIG. 3B. Adjacent display elements 10 and 11 can be aligned such that the pixels of the overlapping display element 10 align with the pixels of the overlapped display element 11. Pixel alignment combined with the substantially flat appearance of the tiled display yields a large format display with minimal visual division or distortion between individual display elements.

FIG. 5 is a front isometric view of a tiled display 9, wherein all of the display elements are covered by a single protective layer 30. The substantially flat nature of the tiled display allows for the tiled display to be treated as a single unit, such that additional layers, such as films, can be applied to the tiled display after assembly. Examples of layers that could be placed over the tiled display include, but are not limited to, insulation layers, barrier layers, laminate layers, and other protective coatings, alone or in any combination. Such additional layers can optionally be applied to each display element individually, or to groups of two or more display elements in a tiled display. Any added layer can cover all or a portion of one or more display elements.

FIG. 6 is a front view of a two-element tiled display 9. The tiled display 9 is formed by two identical display elements rotated 180 degrees from each other, such that the drive electronics 3 and access area 5 are external to the viewing area 15, wherein the viewing area 15 includes at a least a portion of the tiled display 9 that is electronically updatable, and is viewable by an observer. The exemplified configuration enables seamless tiling without requiring the interconnect area 7 to be smaller in length and/or width than the display material.

FIG. 7 is a front isometric view of a tiled display wherein the tiling is in a single direction. Many flexible display technologies enable manufacture of very long display elements 10, 11. Roll-to-roll technologies are particularly capable of creating such long display elements, wherein individual display elements up to thousands of meters long can be manufactured. This enables manufacture of a tiled display 9 wherein a series of display elements 10, 11 are used that are equal in length to one of the desired dimensions (height or width) of the tiled display 9. The other dimension is achieved by tiling the overlapping elements 10 over the overlapped elements 11 in one direction. Alternately, both edges of a given display element can be overlapped, such that the tiled display has bands of overlapped and overlapping display elements. In such a configuration, it is desirable that the access area 5 of the overlapping display element 10 be substantially transparent. Such a tiled display 9 can have seams in only one direction, either horizontal or vertical, improving the overall appearance and simplicity of the tiled display.

FIG. 8 and FIG. 9 demonstrate a method of making a large, tiled display 9, similar to that shown in FIG. 7, but wherein the display media 2 can be arranged in concentric loops. Such a tiled display 9 can have one or more viewing areas. For example, as shown in FIG. 9, two viewing areas 15 are present. The display element loops can be progressively concentric in a given direction of overlap. Alternately, both edges of a given display element can be overlapped, such that the tiled display has bands of overlapped and overlapping display elements. In such a configuration, it is desirable that the access area 5 of the overlapping display element 10 be substantially transparent, or that the display elements are written with relative motion to drive electronics, as described elsewhere herein. Other tiled displays can be similarly formed using concentric arrangements of display elements. For example, display elements can be shaped to form, for example, a U-shape, arc, polygon, or any other regular or irregular shaped tiled display.

FIG. 10 is a back view of an electronically addressable, single-sided, reflective display element with all electrical interconnects routed to one edge. In this embodiment, the display element 2 has a display area 4, an interconnect area 7, and an access area 5. The interconnect area 7 can be along one edge, in this case, the edge including the access area 5. As shown, the display element 2 can be pixilated using rows 17 and columns 18, both of which are routed to connect along a single edge of the display element 2. As shown in FIG. 10, the interconnect area 7 can be narrower than the edge width of the display element 2, leaving unsupported display areas 6 on one or both sides of the interconnect area 7. The display area 4 can also be unsupported. As in the configuration from FIG. 1, the unsupported areas 4, 6 are only as thick as the display element itself.

FIGS. 11A and 11B are front and cross-sectional views of a tiled display using the display element described above and shown in FIG. 10. As in the embodiment described in FIG. 2, the tiled display is formed of display elements 10,11 that are tiled in a vertical and horizontal array. The advantage in using the single-edge interconnect element is that the vertical overlap area 21 can be reduced and the thicker portion of the display element corresponding to the drive electronics 3 and interconnect area 7 can be reduced in area to forming rows of electronics along the tiled display. In this configuration, the entire tiled display can be folded or rolled to reduce size for storage or transportation.

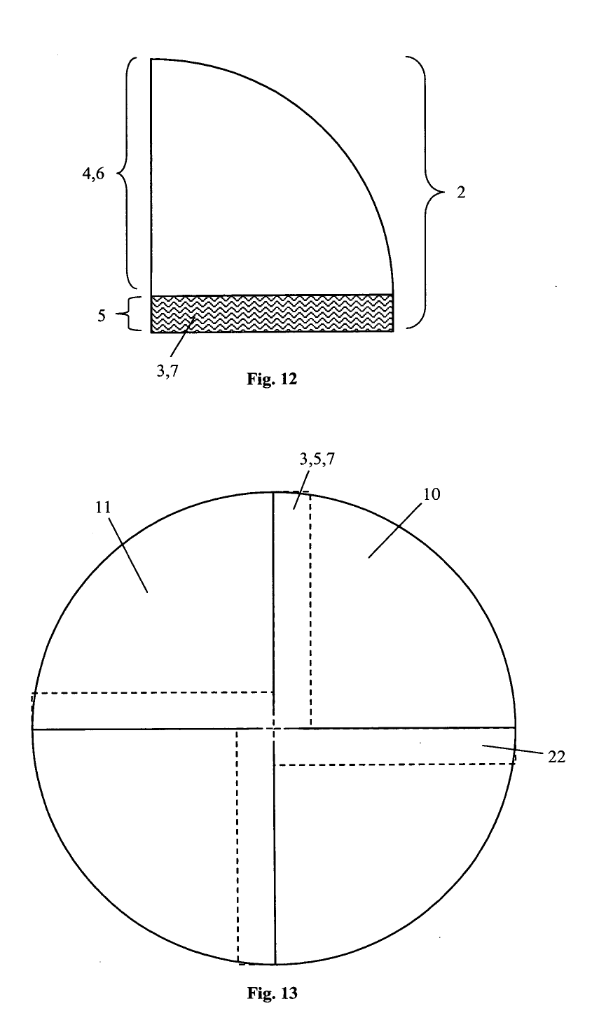

FIG. 12 is an example of a display element that could be used in forming non-rectangular display assemblies. The display material 2 can be designed such that the access area 5 spans the entire width of at least one aspect of the display area 4. This enables the display area 4 to be fully addressed. The unsupported area 6 is sufficiently large to cover at least a portion of the access area 5 of a second display element.

FIG. 13 demonstrates a method of arranging the display elements of FIG. 12 in a circular array, such that each display is both overlapping 10 and overlapped 11. The overlap area 22 covers at least a portion of some or all of the display element access area 5, while leaving access to the display electronics 3 and interconnect area 7 from the back of the assembly. This embodiment gives the appearance of a completely addressable, non-rectangular display when viewed from the front. Although this embodiment shows the assembly constructed of four identical elements, this is not necessary. The elements could be of different shapes, sizes, or a combination thereof, and of any number, yielding a multitude of final tiled display shapes.

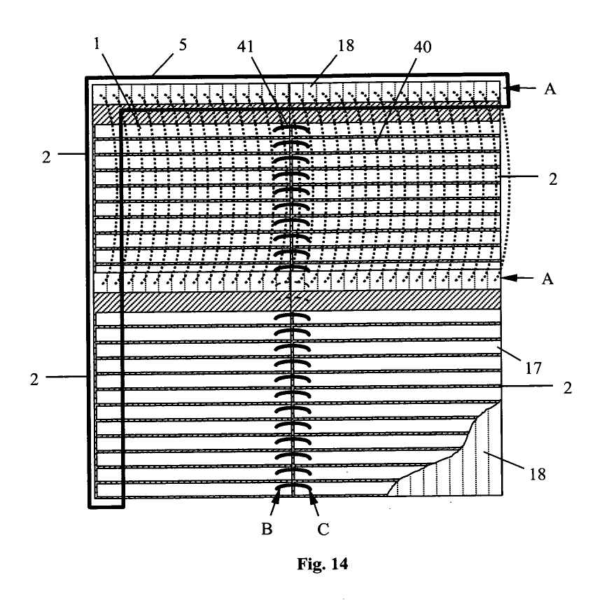

FIG. 14 is a back view of a tiled display wherein each display element has rows 17 and columns 18 of electrically addressable materials, as shown in FIG. 10. As can be seen from the cut-away section in FIG. 14, the rows 17 overlap the columns 18. The rows 17 and columns 18 of each display element 2 can be connected to the rows 17 and columns 18 of at least one adjacent display element 2. This type of tiling can be referred to as “continuous tiling.” A continuously tiled system reduces the total number of drive channels required to write the tiled display. In non-continuous tiled displays, the total number of drive channels (T_{c}) equals:
T_{c}=(Rₑ+Cₑ)Nₑ (1)
where Rₑ is the number of rows in a display element, Cₑ is the number of columns in a display element, and Nₑ is the number of display elements. For example, if a tiled display includes 600 rows and 800 columns by combining four 300 row×400 column displays, then the total number of drive channels would be (300+400)·4, or 2800, channels. However, in the continuous tiled display, the total number of drive channels equals:
T_{c}=(Rₐ+Cₐ) (2)
where Rₐ is the number of rows in the tiled display, and Cₐ is the number of columns in the tiled display. That means that the same 600 row by 800, column display described in the previous example would only require (600+800), or 1400, drive channels.

The continuous tiling connections can be configured in a variety of ways including, but not limited to, start-to-start (STS) jumpers 40, wherein electrical connections are made between traces on a first edge of two adjacent display elements (A to A), or end-to-start (ETS) jumpers 41, wherein electrical connections are made between traces on a second edge of a first display element (B) and an adjacent edge of an adjacent display element (C). Both STS and ETS jumpers can be traces, wire bonding, printed conductors, conductive tape, or any other electrically connective material known to practitioners in the art. If the display material is flexible, ETS jumpers can enable connections made by folding the edge of the overlapped display and attaching its traces directly to those of the overlapping display. The advantage of STS jumpers is that only one interconnect point is required for each row 17 or column 18. The advantage of ETS jumpers is that the connection distance is relatively short. This can be useful in forming two-sided display assemblies.

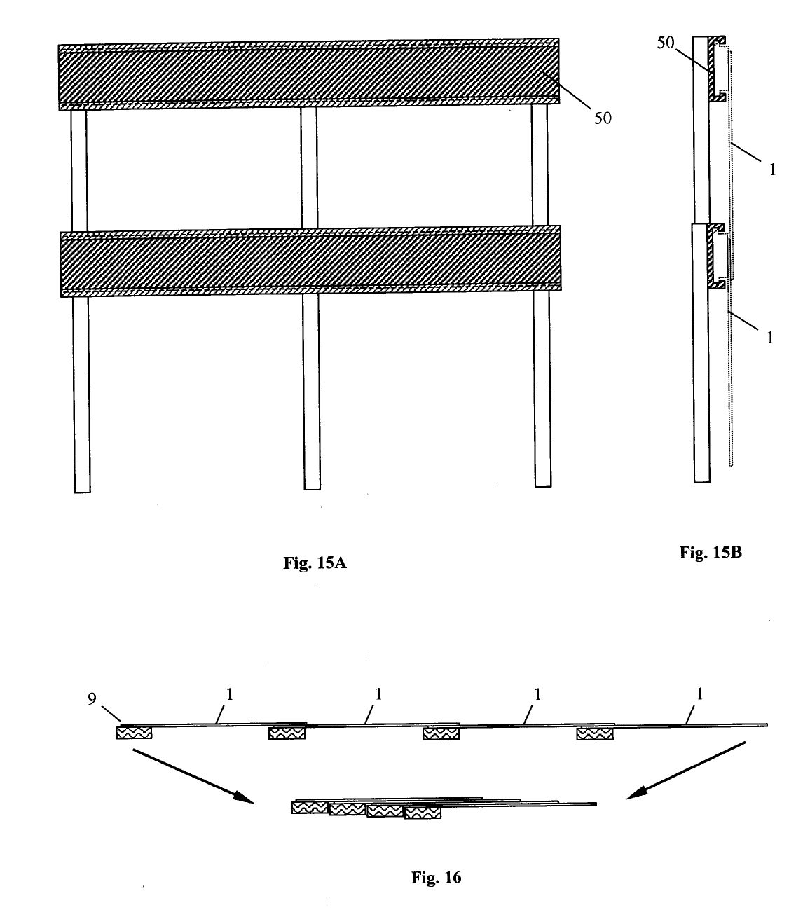

FIGS. 15A and 15B are a front and side view of a support assembly 50 that can be used in aligning, holding, or powering display elements. Individual display elements or display assemblies 1 can be designed such that they mechanically and/or electrically attach to the support assembly 50, which can hold the display elements or display assemblies 1 in place relative to each other. The support assembly 50 can optionally provide power, control signals, or both to one or more display assembly 1. This allows the display assembly 1 to contain only minimum drive electronics. The support system 50 can be designed to assemble and disassemble or telescope and collapse easily, allowing the tiled display to be assembled on location without special equipment. The supports can be adjustable to enable use of varied display element lengths and widths. Ease of assembly and disassembly enables portability of the tiled display for use in trade shows or temporary venues, and can provide increased versatility in placement and configuration of the tiled displays.

FIG. 16 demonstrates the ability of a tiled display 9 to be expanded and collapsed through a telescoping mechanism. Individual display elements or assemblies 1 can be stacked one in front of another without having to separate them from adjacent display elements or assemblies, or optionally a support. The tiled display 9 can be reduced in size any desirable amount by increasing the amount of overlap between the display assemblies. The telescoping and collapsing mechanism can be employed whether sheet-like display elements or continuous loops are employed. Various three-dimensionally shaped tiled displays can be nested such that all rows within the tiled display can move past each other to collapse or expand the display size. Where the tiled display is a non-rectangular shape, such as in FIG. 13, the display assemblies can be collapsed in a non-linear fashion. For example, the tiled display of FIG. 13 can be collapsed to the dimensions of a single display assembly within the tiled display.

The invention has been described in detail with particular reference to certain preferred embodiments thereof, but it will be understood that variations and modifications can be effected within the spirit and scope of the invention.

### PARTS LIST

1 display assembly
2 display element
3 drive electronics
4 display area
5 access area
6 unsupported display area
7 interconnect area
9 tiled display
10 overlapping display element
11 overlapped display element
15 viewing area
17 row
18 column
20 vertical overlap area
21 horizontal overlap area
22 overlap area
30 protective layer
40 STS jumper
41 ETS jumper
50 support assembly

1. An electronic, rewritable display having a viewing area, wherein the viewing area comprises a plurality of display elements, each of the plurality of display elements comprising an overlap area, an access area, an interconnect area, and a display area, wherein the overlap area of at least one of the plurality of display elements overlaps at least a portion of the display area of at least a second one of the plurality of display elements, and wherein at least a portion of one of the plurality of display elements is flexible.

2. The display of claim 1, wherein at least one of the plurality of display elements additionally overlaps at least a portion of the access area of a third of the plurality of display elements.

3. The display of claim 1, wherein at least one of the plurality of display elements has an interconnect area not touching an edge of the display element.

4. The display of claim 1, wherein at least one of the plurality of display elements has drive electronics electrically connected to the interconnect area.

5. The display of claim 4, wherein the drive electronics of at least one of the plurality of display elements do not extend to at least one edge of the display element.

6. The display of claim 4, wherein the drive electronics of at least one of the plurality of display elements do not extend to at least one edge of the display area.

7. The electronic display of claim 1, wherein the viewing area extends to at least one edge of the electronic display.

8. The electronic display of claim 1, wherein the overlapped display elements are not linearly arranged.

9. The electronic display of claim 1, wherein the overlap area comprises at least a portion of the access area.

10. The electronic display of claim 1, wherein at least one of the plurality of display elements comprises liquid crystal display material.

11. The electronic display of claim 1, wherein at least one of the plurality of display elements comprises a bistable material.

12. The electronic display of claim 1, wherein at least one of the plurality of display elements comprises a color different from at least one other of the plurality of display elements.

13. The electronic display of claim 1, wherein at least a portion of the overlap area is thinner than the remainder of the display element.

14. The electronic display of claim 1, wherein at least one of the plurality of display elements is different in size, shape, or a combination thereof from at least one other of the plurality of display elements.

15. The electronic display of claim 1, wherein at least one of the plurality of display elements has a polygonal shape, irregular shape, curved shape, or is a loop.

16. The electronic display of claim 1, wherein at least one of the plurality of display elements is pixilated, segmented, or a combination thereof.

17. The electronic display of claim 1, wherein each one of at least a portion of the plurality of display elements comprises at least one alignment feature.

18. The electronic display of claim 17, wherein alignment features of adjacent ones of the plurality of display elements physically interact.

19. The electronic display of claim 17, wherein the alignment feature is an electrical interconnect.

20. The electronic display of claim 1, wherein each of the plurality of display elements comprises an electrically addressable matrix of first conductive elements and second conductive elements, and wherein the first conductive elements or the second conductive elements of two or more of the plurality of display elements are connected and commonly addressable.

21. The electronic display of claim 1, wherein one or more of the plurality of display elements is removably overlapped.

22. The electronic display of claim 1, wherein each of the display elements is movable relative to at least one other display element.

23. The electronic display of claim 1, wherein at least a portion of the viewing area is covered by a protective layer.

24. The electronic display of claim 1, wherein the interconnect area and the access area are at least partially coincident.

25. The electronic display of claim 1, having more than one viewing area.

26. The electronic display of claim 25, wherein at least one viewing area is non-planar in relation to at least one other viewing area.

27. The electronic display of claim 1, wherein the electronic display is foldable, rollable, or collapsible.

28. An expandable signage system, comprising at least one electronic display of claim 1.

29. The expandable signage system of claim 28, further comprising at least one support.

30. The expandable signage system of claim 29, wherein the display elements are slidable, removable, or a combination thereof with respect to one or more support.

31. The expandable signage system of claim 28, further comprising a base supporting the electronic display.

32. The expandable signage system of claim 28, wherein the electronic display comprises drive electronics, and the signage system comprises a driver for controlling the drive electronics.

33. The expandable signage system of claim 28, wherein one or more of the display elements is stackable, slidable, removable, or a combination thereof with respect to other display elements.

34. The expandable signage system of claim 28, wherein the system is foldable, rollable, or collapsible.

35. A method of forming the expandable signage system of claim 28, comprising joining two or more electronic display physically, electrically, or a combination thereof.

36. A method of forming an electronic display of claim 1, comprising overlapping the overlap area of a first display element with the display area of a second display element.

37. The method of claim 36, further comprising repeating the step of overlapping display elements in at least one direction until a desired viewing area dimension is obtained.

38. The method of claim 36, further comprising overlapping the overlap area of the first display element with the interconnect area of a third display element.

39. The method of claim 36, further comprising pre-writing or pre-printing at least one of the display elements.

40. A method of expanding or contracting the electronic display of claim 1, comprising rolling, folding, unrolling, or unfolding the display.

41. A method of expanding or contracting the display of claim 1, comprising slidably moving each of the plurality of display elements to increase or decrease the overlap area of at least a portion of the display elements.

42. A method of expanding or contracting the display of claim 1, comprising removing or adding at least one display element.
